(19) United States
(12) Patent Application Publication
(10) Pub. No.: US 2009/0326425 A1
(43) Pub. Date: Dec. 31, 2009

(54) Medical Device For Treatment Of The Human Or Animal Body By Mechanical Pressure Waves Or Shock Waves

(76) Inventors: Gerold Heine, Ohningen (DE); Juergen Mayer, Reichenau (DE); Josef Katona, Radolfzell (DE)

Correspondence Address: ST. ONGE STEWARD JOHNSTON & REENS, LLC, 986 BEDFORD STREET, STAMFORD, CT, 06905-5619, US

(21) Appl. No.: 12/488,693

(22) Filed: Jun. 22, 2009

Related U.S. Application Data
(63) Continuation of application No. PCT/EP2007/010964, filed on Dec. 13, 2007.

(30) Foreign Application Priority Data
Dec. 22, 2006 (DE) 10 2006 062 356.8

(51) Int. Cl. A61H 23/04

(52) U.S. Cl. 601/108

(57) ABSTRACT

A medical device for treatment of the human or animal body by mechanical pressure waves or shock waves comprises a device which generates the pressure waves or shock waves and which has at least one percussion part that can be moved to and fro, a pneumatic drive for the at least one percussion part, for applying pressure to the at least one percussion part, and at least one impact body against which the at least one percussion part strikes in order to generate the pressure waves or shock waves in the impact body, and a control system for the pneumatic drive. The control system controls the pneumatic drive during operation in such a way that the pressure during at least two successive strikes of the at least one percussion part against the impact body is applied continuously to the at least one percussion part, with the result that the at least one percussion part executes these at least two successive strikes in a time interval within a range of 2 ms to 30 ms.

### CROSS REFERENCE TO RELATED APPLICATIONS

The present application is a continuation of international patent application PCT/EP 2007/010964 filed on Dec. 13, 2007, which designates the United States, and which claims priority of German patent application 10 2006 062 356.8 filed on Dec. 22, 2006.

### BACKGROUND OF THE INVENTION

The invention generally relates to medical devices for treatment of the human or animal body by mechanical pressure waves or shock waves.

More specifically, the invention relates to a medical device for treatment of the human or animal body by mechanical pressure waves or shock waves, comprising an apparatus which generates the pressure waves or shock waves and which has at least one percussion part that can be moved to and fro, a pneumatic drive for the at least one percussion part, for applying pressure to the at least one percussion part, and at least one impact body against which the at least one percussion part strikes in order to generate the pressure waves or shock waves in the impact body, and with a control system for the pneumatic drive.

Within the meaning of the present invention, “treatment of the human or animal body” is to be understood, for example, as treatment of soft tissue, in particular for alleviating pain, treatment of bone tissue, breaking up of stones in the body, removal of plaque from vessels, treatment of teeth, but also removal of bone cement or driving-in of bone nails or wires.

A medical device known from DE 197 25 477 C2 is used for treatment of bone fractures, enthesopathies, tendinopathies and also periodontosis. Another field of use of this known device is the treatment of pain in the soft-tissue areas of the locomotor and support system located near bone. All these uses of the known medical device can also be carried out with the medical device according to the present invention.

The known device comprises, as its apparatus for generating the pressure waves or shock waves, a periodically movable percussion part, a pneumatic drive for the at least one percussion part, at least one impact body, and a control system for the pneumatic drive. The percussion part of the known medical device is a projectile that can be moved to and fro along a straight acceleration path and which is driven by compressed air between a proximal starting position and a distal end position, in which the percussion part strikes against the impact body.

In the known device, pressure from a pressure source is applied periodically to the percussion part, and the application of pressure to the percussion part is interrupted between each strike of the percussion part against the impact body, such that the percussion part can travel back to its proximal starting position. The periodic application of pressure to the percussion part is effected by the control of a valve between the compressed air source and the compressed air connector at the proximal end of the handpiece in which the percussion part is arranged. In view of the fact that, after each renewed opening of the valve following an interruption of the pressure application, the pressure provided from the compressed air source via the compressed air line has to build up again, the apparatus for generating the pressure waves or shock waves in the known device has a certain inertia, to which the finite switching times of the valve additionally contribute. The consequence of this is that the strike frequency of the percussion part in the known device does not exceed 30 Hz. However, in many uses of such a medical device, it is desirable to generate mechanical pressure waves or shock waves at a higher generation rate.

In order to achieve a higher strike frequency of the percussion part in the known device, the acceleration path of the percussion part could be made shorter, but this has the disadvantage that the percussion part does riot have a sufficient end velocity upon striking the impact body, which end velocity is intended to be between 5 m/s and 20 m/s in the known device.

Further medical devices for treatment of the human or animal body by mechanical pressure waves or shock waves, which are based on the same concept of generating pressure waves or shock waves as in the known device mentioned above, are known from the documents DE 198 59 135 A1, DE 196 18 972 A1 and DE 196 24 446 C1. The instrument known from the first document is used to drive wire pins into bone substance, which is understood here also as treatment of the human or animal body. The second document discloses a medical device for breaking up stones in the body, and the third document relates to a medical device for removal of bone cement. The medical device of the present invention is likewise suitable for these applications.

### SUMMARY OF THE INVENTION

The object of the invention is to make available a medical device which is of the type mentioned at the outset and by means of which pressure waves or shock waves can be generated with a higher strike frequency.

According to the invention, a medical device for treatment of the human or animal body by mechanical pressure waves or shock waves is provided, comprising an apparatus for generating the pressure waves or shock waves, the apparatus for generating the pressure waves or shock waves comprising at least one percussion part that can be moved back and forth, a pneumatic drive for the at least one percussion part, for applying pressure to the at least one percussion part, at least one impact body against which the at least one percussion part strikes in order to generate the pressure waves or shock waves in the impact body, and a control system for the pneumatic drive, the control system controlling the pneumatic drive during operation in such a way that the pressure during at least two successive strikes of the at least one percussion part against the impact body is applied continuously to the at least one percussion part such that the at least one percussion part executes the at least two successive strikes in a time interval within a range of 2 ms to 30 ms.

In the medical device according to the invention, the application of pressure to the at least one percussion part is not, as in the known device, interrupted after each strike of the at least one percussion part against the impact body, and instead the pressure is applied over the course of at least two successive strikes of the at least one percussion part against the impact body. At the start of a pressure application period, the percussion part is first accelerated from its proximal starting position toward the impact body and then strikes against the impact body, from which the percussion part then rebounds and is moved back again in the direction of its starting position, in which return movement it runs against the continuously applied pressure and, in doing so, is slowed to zero velocity. With pressure continuously being applied, the percussion part is then accelerated back in the distal direction and strikes a second time against the impact body, the time interval between the two aforementioned strikes lying within a range of 2 ms to 30 ms (milliseconds), preferably 2 ms to 20 ms. This time interval between the two successive strikes is shorter than in the known device and is made possible by the fact that the pressure does not have to be built up again after an interruption of the pressure application, as in the known device, but instead is applied continuously to the percussion part, and, in addition, by the fact that finite valve switching times likewise do not delay the renewed build up of pressure.

In principle, the control system can be configured such that it allows pressure to be applied to the percussion part until the latter has executed a sequence of several successive strikes, for example five or more successive strikes.

The return movement of the at least one percussion part after striking against the impact body takes place under continuous application of pressure and can be effected by the rebound alone or by the return movement being assisted by means of a counterpressure that is generated in a retainment chamber, for example, as in the known device.

With the device according to the invention, pressure waves or shock waves can be generated with a mean strike frequency that clearly exceeds the strike frequencies of the known device, as a result of which the effectiveness of the device according to the invention in the treatment of biological tissue for example, particularly in pain therapy, can be improved.

Preferably, the at least one percussion part, under continuously applied pressure, executes at least five successive strikes against the impact body.

The possible number of successive strikes of the at least one percussion part under continuously applied pressure will depend oil how high the pressure applied to the at least one percussion part is, and on how long the acceleration path of the percussion part is, which path becomes shorter after each strike.

A mean strike frequency of the at least one percussion part, under continuously applied pressure, preferably lies within the range of 30 Hz to 200 Hz (hertz).

In this frequency range, which clearly exceeds the frequency range of the known device, particularly good therapeutic effects can be achieved in certain applications, especially in pain therapy.

In another preferred embodiment, an impact velocity of the at least one percussion part, at least in the first strike against the impact body, lies within the range of 20 m/s to 60 m/s (meters/second) upon application of pressure to the at least one percussion part.

Such a high impact velocity of the percussion part in the first strike against the impact body has the advantage that a sufficiently high impact velocity is still achieved in the at least one further strike of the percussion part against the impact body under continuously applied pressure. It should be noted here that, under continuously applied pressure, the acceleration path of the percussion part can become shorter after each strike, such that in this embodiment too a sufficiently high impact velocity of the percussion part for generating mechanical pressure waves or shock waves in the impact body is still available after a sequence of, for example, five successive strikes under continuously applied pressure.

In another preferred embodiment, the application of pressure to the at least one percussion part is interrupted after the at least two strikes of the at least one percussion part and is recommenced after an interruption time.

The advantage of this is that, after a defined number of successive strikes of the at least one percussion part against the impact body under continuously applied pressure, the percussion part is able to return to its original starting position as a result of the interruption in the application of pressure, after which the application of pressure starts again and then, as has been described above, a sequence of at least two strikes against the impact body takes place under continuously applied pressure. With this embodiment, the device according to the invention can therefore advantageously run in continuous operation.

An impact velocity of the at least one percussion part is preferably greater than 3 m/s at the last strike against the impact body prior to interruption of the application of pressure to the at least one percussion part.

The advantage of this is that the last strike of the at least one percussion part against the impact body prior to interruption of the pressure application can also generate a pressure wave or shock wave of sufficient energy.

In connection with both of the aforementioned embodiments, a repetition frequency of the application of pressure to the at least one percussion part is less than 1/T, where T is the duration of a continuous application of pressure to the at least one percussion part.

The repetition frequency of the application of pressure to the at least one percussion part is thus adapted to the duration of the continuous application of pressure and, in particular, can be set in such a way that the mechanical pressure waves or shock waves can be generated at a continuously high frequency.

In another preferred embodiment, the device according to the invention has an applicator via which the pressure waves or shock waves generated in the impact body are introduced into the human or animal body, the applicator being formed by the impact body itself.

This measure results in a structurally simple design of the device, in which the pressure waves or shock waves are generated in the applicator itself, from which they can then be introduced into the body of a patient.

Within the meaning of the present invention, the generation of pressure waves or shock waves is to be understood at least also as a limited translatory movement of the impact body or applicator, or in other words a translatory movement of this kind is also a source of the generation of the pressure waves or shock waves.

For effective generation of pressure waves or shock waves, a maximum stroke of the applicator is preferably less than or equal to 2 mm, preferably less than or equal to 0.5 mm.

It is also preferable that a velocity of the applicator after being struck by the least one percussion part is less than or equal to 5 m/s.

In connection with the aforementioned preferred dimension of the maximum stroke of the applicator, and particularly when the percussion part has a very high strike frequency and pressure is applied continuously, it is possible for the applicator to be struck by the percussion part before said applicator has returned to its rest position. In other words, the applicator experiences two successive strikes, for example, before it has returned to its rest position.

For the use of the medical device according to the invention for pain therapy, the applicator has a blunt distal end, such that the applicator can be placed onto the surface of the skin of a patient, without injuring the skin.

In other preferred embodiments, the impact body is composed of one or more metals, a metal alloy and/or a plastic, and the at least one percussion part is also preferably composed of one or more metals, a metal alloy and/or a plastic.

It is also preferable if the at least one percussion part is harder than the impact body.

A maximum stroke of the back and forth movement of the at least one percussion part is preferably greater than or equal to 5 cm.

The pressure provided by the pneumatic drive is preferably less than or equal to 6 bar.

It is also preferable for a plurality of percussion parts to strike against the impact body.

The provision of a plurality of percussion parts advantageously allows the strike frequency to be increased, for example by pressure being applied to the percussion parts independently of one another, as is provided for in another preferred embodiment. The percussion parts can thus strike against the impact body at short time intervals one after the other, if it is preferred to increase the strike frequency.

In order to increase the strike energy, the percussion parts preferably strike against the impact body together.

If the pneumatic drive of the device according to the invention has a plurality of percussion parts, these preferably run in tubes which are arranged concentrically with respect to one another and to each of which pressure can preferably be applied separately.

Furthermore, the pneumatic drive of the device according to the invention preferably has at least one valve which can be controlled by the control system and via which pressure is applied to the at least one percussion part.

The pneumatic drive can also preferably have at least two valves which can be controlled by the control system and which can be controlled separately, preferably alternately.

The advantage of this is that, by alternate opening and closing of the at least two valves, the idle times caused by the finite switching times of the valves can be further reduced. By suitable control of the valves, it is also advantageously possible to generate a defined profile of the pressure wave or shock wave.

As has already been mentioned above, a retainment chamber is preferably provided at a side of the at least one percussion part directed away from the pressure application side.

During the forward movement of the at least one percussion part, this retainment chamber is subjected increasingly to pressure which, after the at least one percussion part strikes against the impact body, aids the return movement of the percussion part, particularly at the moment when the application of pressure to the percussion part is temporarily interrupted, such that the percussion part can travel back again to its proximal starting position.

Further advantages and features will become evident from the following description and from the attached drawing.

It will be understood that the aforementioned features and the features to be explained below can be used not only in the respectively cited combination, but also in other combinations or alone, without departing from the scope of the present invention.

### BRIEF DESCRIPTION OF THE DRAWINGS

Illustrative embodiments of the invention are depicted in the drawing and are described in more detail below with reference to said drawing, in which:

FIG. 1 shows a medical device for treatment of the human or animal body by mechanical pressure waves or shock waves, in longitudinal section, in which a pneumatic drive and a control system of the medical device are partially depicted in a block diagram;

FIG. 2 shows a speed-time curve depicting the impact velocity of the percussion part in five successive strikes of the percussion part under continuous application of pressure to the percussion part;

FIG. 3 shows, in schematic longitudinal section, an illustrative embodiment of a medical device which is used for treatment of the human or animal body by mechanical pressure waves or shock waves and which has been modified in relation to FIG. 1.

### DETAILED DESCRIPTION OF PREFERRED EXEMPLARY EMBODIMENTS

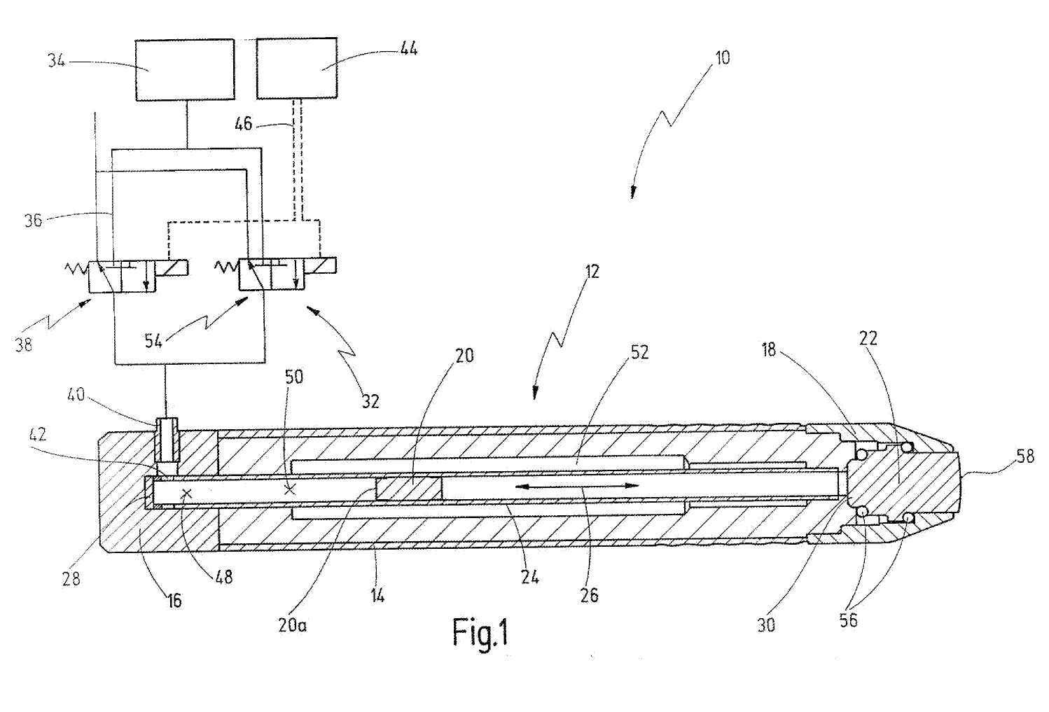

In FIG. 1, a medical device for treatment of the human or animal body by mechanical pressure waves or shock waves is designated overall by reference number 10. The device 10 is used in particular for soft-tissue treatment in the context of pain therapy.

The device 10 is basically designed as a handpiece 12 that the person using the device 10 holds in his or her hand like a rod.

The handpiece 12 has a housing 14 which has a proximal end cap 16 at the proximal end and a distal end cap 18 at the distal end, both of which end caps can preferably be removed.

The device 10 generally comprises an apparatus for generating mechanical pressure waves or shock waves and which has at least one percussion part 20, in the present illustrative embodiment one percussion part 20 that can be moved to and fro, and at least one impact body 22, in the illustrative embodiment one impact body 22.

The percussion part 20 is arranged in a guide tube 24 in the housing 14 and can be moved to and fro therein in the directions of a double arrow 26. The maximum path of movement, or the maximum stroke, of the percussion part 20 is limited in the proximal direction by a limit stop 28 and in the distal direction by a proximal end 30 of the impact body 22. The proximal limit stop 28 can also be designed as a magnet holder.

The total length of the guide tube 24 between the limit stop 28 and the impact body 22 is at least 5 cm, and, consequently, the maximum stroke of the reciprocating movement of the percussion part 20 is at least 5 cm also.

To set the percussion part 20 in motion, a pneumatic drive 32 is provided which applies pressure to the percussion part 20 during the operation of the device 10.

The pressure is provided by a pressure source 34 which is designed, for example, in the form of a compressor or in the form of a container filled with compressed gas, in particular with compressed air.

The pressure source 34 is connected to the interior of the guide tube 24 by way of a pressure line 36, a valve 38 and a pressure connector piece 40, with a corresponding opening 42 being provided in the guide tube 24 at the proximal end. The valve 38 is a controllable valve, in particular a solenoid valve.

For the pneumatic drive 32, a control system 44 is also provided, which controls the valve 38 by way of a control line 46 (indicated by broken lines).

The control system 44 and/or the valve 38 can also be integrated into the handpiece 12.

The control system 44 controls the pneumatic drive 32 during operation of the device 10 in such a way that the pressure provided by the pressure source 34 is applied continuously to the percussion part 20 during at least two successive strikes of the percussion part 20 against the impact body 22, with the result that the percussion part 20 executes these at least two successive strikes in a time interval within a range of 2 ms to 30 ms, preferably of 2 ms to 20 ms.

Starting from an idle state of the device 10 in which the valve 38 is closed, said valve 38 is opened by the control system 44. When the valve 38 is a three-way/two-way valve, “valve closed” means that no pressure is applied to the percussion part 20, and instead the guide tube 24 is vented. Before the valve 38 is opened, the percussion part 20 is located in its starting position, which is designated by reference number 48 in FIG. 1. By means of the pressure building up against the proximal end 20a of the percussion part 20 when the valve 38 is open, the percussion part 20 is accelerated in the direction of the impact body 22 and strikes against the proximal end 30 of the impact body 22, as a result of which a mechanical pressure wave or shock wave is generated in the impact body 22. The percussion part 20 rebounds from the impact body 22 and moves back in the proximal direction in the guide tube 24. During this return movement, the valve 38 is further opened, such that further pressure is applied in the guide tube 24 at the proximal end of the percussion part 20. The percussion part 20 is slowed down in its return movement by this application of pressure and no longer reaches its original starting position 48; instead it reaches a position 50 which depends on the pressure and on the impulse of the percussion part 20 and in which the percussion part 20 is slowed down to zero velocity. The pressure being further applied now accelerates the percussion part 20 back in the distal direction from the position 50, such that the percussion part 20 once again strikes against the proximal end 30 of the impact body 22, in order to generate a further pressure wave or shock wave in the impact body 22.

The time interval between the first strike and the second strike of the percussion part 20 against the impact body 22 lies within the range of 2 ms to 30 ms.

This procedure can now continue, i.e. the valve 38 can remain further open, such that the percussion part 20 executes at least one further strike against the impact body 22 while pressure is applied continuously, but the acceleration path of the percussion part 20 becomes ever shorter, since the percussion part 20, after each strike against the impact body 22, travels back less far in the proximal direction, because the energy of the percussion part dissipates on account of friction losses and as a result of energy being output to the impact body 22.

The return travel of the percussion part 20 after its strike against the impact body 22 can be assisted by a retainment chamber 52 into which the medium (usually air) located to the distal side of the percussion part 20 in the guide tube 24 is displaced during the forward movement of the percussion part 20 toward the impact body 22, as a result of which a counterpressure is built up in the retainment chamber 52, and, after the percussion part 20 strikes against the impact body 22, this counterpressure aids the rearward movement of the percussion part 20 in the proximal direction.

Provision can also be made that, after each strike against the impact body 22, the rearward movement of the percussion part 20 is actively assisted by a pressure medium that is delivered to the retainment chamber 52 from the outside.

If an active counterpressure of this kind is not used, the percussion part 20 will no longer move back sufficiently far in the proximal direction after a certain number of strikes against the impact body 22 with the valve 38 continuously open. The control system 44 therefore closes the valve 38 after at least two strikes of the percussion part 20 against the impact body 22, for example after five strikes, as a result of which pressure is no longer applied on the proximal side of the percussion part 20, with the result that the percussion part 20 can travel back to its starting position 48. Thereafter, the valve 38 is opened again, and the procedure described above takes place again.

The percussion part 20 preferably executes at least five successive strikes against the impact body 22 while pressure is continuously applied.

The pressure applied against the proximal end of the percussion part 20 and the acceleration path between the starting position 48 and the impact body 22 are chosen depending on the weight of the percussion part 20 and on the cross section of the proximal end 20a of the percussion part 20, in such a way that, after each opening of the valve 38, i.e. at the first strike against the impact body 22, the percussion part 20 strikes against said impact body 22 with an impact velocity in the range from 20 m/s to 60 m/s.

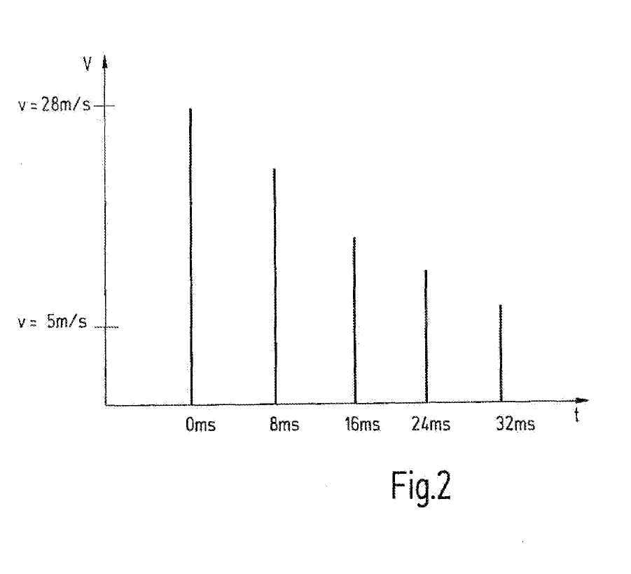

Because of the continuously decreasing acceleration path, the strikes following the first strike take place at lower impact velocities, as is illustrated by way of example in FIG. 2.

FIG. 2 shows an example of a speed-time curve for the percussion part 20. The first strike takes place with an impact velocity of 28 m/s, the second strike, which follows the first strike at a time interval of 8 ms, takes place with an impact velocity of about 22 m/s, etc. The last strike of the percussion part 20 prior to the interruption of the pressure application takes place with an impact velocity greater than 3 m/s, according to FIG. 2 greater than 7 m/s.

The valve 38 is opened and closed with a repetition rate or repetition frequency of less than 1/T, where T is the duration of the continuous application of pressure to the percussion part 20.

The mean strike frequency of the percussion part 20, under continuous application of pressure, lies within the range of 30 Hz to 200 Hz.

Since the valve 38 for opening and closing requires a finite switching time, it is possible, as shown in FIG. 1, to provide a second valve 54, which is likewise connected to the pressure source 34 and to the control system 44. The valve 54 can be opened and closed alternating with the valve 38. For example, just when the valve 38 is closed, the valve 54 can be opened in order to keep the period of interruption in the application of pressure to the percussion part 20 as short as possible. The interruption in the application of pressure must in fact only be of such duration that the percussion part 20 is able to return to a suitable starting position, for example to the starting position 48, from which a sufficient acceleration path is available for the percussion part 20. With at least two valves, the pressure can as a whole be built up more rapidly than with just one valve. The provision of at least two valves can also be used to generate defined pressure profiles.

In the illustrative embodiment shown, the impact body 22 serves not only to generate the pressure waves or shock waves, but also to introduce these waves into the human or animal body, i.e. the impact body 22 serves at the same time as an applicator for the pressure waves or shock waves.

When struck by the percussion part 20, the impact body 22 executes a small stroke of ≦2 mm, preferably a stroke of ≦0.5 mm. However, the stroke can also be greater than 2 mm, depending on the intended use of the device 10.

The impact body 22 is supported proximally and distally in the distal end cap 18 by two damping elements 56.

The velocity of the impact body or applicator 22 after being struck by the percussion part 20 is preferably ≦5 m/s.

For use of the medical device 10 for soft-tissue treatment, particularly in pain therapy, a distal end 58 of the impact body or applicator 22 has a blunt configuration, in the depicted illustrative embodiment with a convex curvature.

The impact body 22 is composed of one or more metals, a metal alloy and/or a plastic. The percussion part 20 is likewise composed of one or more metals, a metal alloy and/or a plastic. It is preferable for the percussion part 20 to be harder than the impact body 22.

The pressure provided by the pneumatic drive 32 and applied to the percussion part 20 is ≦6 bar.

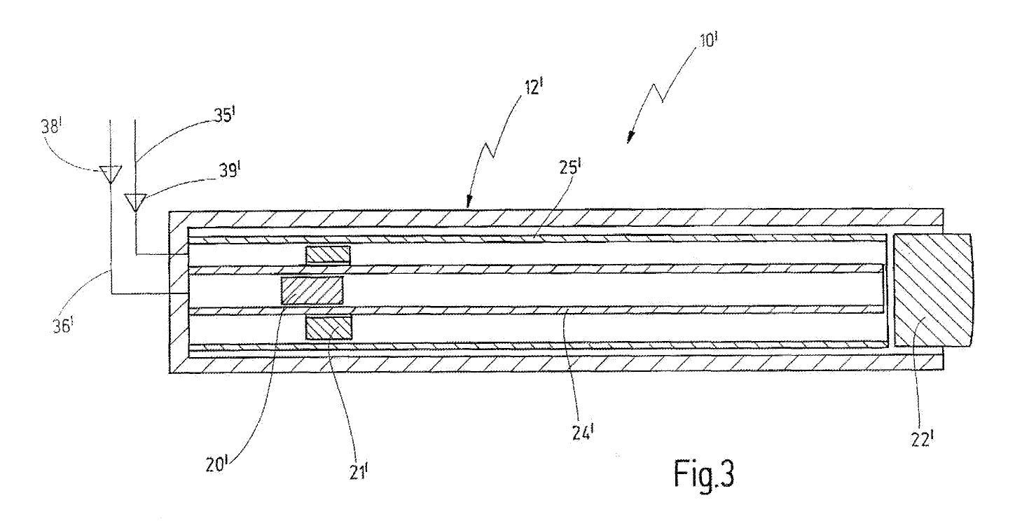

FIG. 3 shows an illustrative embodiment of a medical device 10′ that has been modified in relation to FIG. 1. The features of the device 10′ that are comparable to features of the device 10 have been provided with the same reference numbers with addition of a prime.

Whereas the device 10 has only one percussion part 20, the device 10′ has a plurality of percussion parts, here two percussion parts 20′, corresponding to the percussion part 20, and a further percussion part 21. Alongside the guide tube 24′ for the percussion part 20′, a further guide tube 25′ is provided which concentrically surrounds the guide tube 24′ and in which the percussion part 21 configured as a ring can be moved to and fro.

Pressure can be applied to the two guide tubes 24′ and 25′ independently of each other, with a pressure line 36′ being provided for the guide tube 24′, and a pressure line 35′ being provided for the guide tube 25′. Controllable valves 38′ and 39′ are assigned independently of each other to the pressure lines 36′ and 35′.

Instead of a concentric arrangement, an arrangement of several guide tubes adjacent to one another is also conceivable, in which case the individual percussion parts are then not ring-shaped like the percussion part 20, but instead can be cylindrical.

The valves 38′ and 39′ can be controlled, for example, in such a way that the percussion parts 20′ and 21′ alternately strike against the impact body 22′, or, in order to increase the impact action and therefore the energy of the pressure waves or shock waves generated in the impact body 22′, the two percussion parts 20′ and 21′ can strike against the percussion part 22′ together.

What is claimed is:

1. A medical device for treatment of the human or animal body by mechanical pressure waves or shock waves, comprising
an apparatus for generating said pressure waves or shock waves, said apparatus for generating said pressure waves or shock waves comprising
at least one percussion part that can be moved back and forth,
a pneumatic drive for the at least one percussion part, for applying pressure to said at least one percussion part,
at least one impact body against which said at least one percussion part strikes in order to generate said pressure waves or shock waves in said impact body, and
a control system for said pneumatic drive, said control system controlling said pneumatic drive during operation in such a way that said pressure during at least two successive strikes of said at least one percussion part against said impact body is applied continuously to said at least one percussion part such that said at least one percussion part executes said at least two successive strikes in a time interval within a range of 2 ms to 30 ms.

2. The device of claim 1, wherein said at least one percussion part, under continuously applied pressure, executes at least five successive strikes against said impact body.

3. The device of claim 1, wherein a mean strike frequency of said at least one percussion part, under continuously applied pressure, lies within a range of 30 Hz to 200 Hz.

4. The device of claim 1, wherein an impact velocity of said at least one percussion part, at least in a first strike against said impact body, lies within a range of 20 m/s to 60 m/s upon application of pressure to said at least one percussion part.

5. The device of claim 1, wherein an application of pressure to said at least one percussion part is interrupted after said at least two strikes of said at least one percussion part and is recommenced after an interruption time.

6. The device of claim 5, wherein an impact velocity of said at least one percussion part is greater than 3 m/s at a last strike against said impact body prior to interruption of said application of pressure to said at least one percussion part.

7. The device of claim 5, wherein a repetition frequency of said application of pressure to said at least one percussion part is less than 1/T, where T is a duration of a continuous application of pressure to said at least one percussion part.

8. The device of claim 1, further comprising an applicator via which said pressure waves or shock waves generated in said impact body are introduced into a human or animal body, said applicator being formed by said impact body itself.

9. The device of claim 8, wherein a maximum stroke of said applicator is less than or equal to 2 mm.

10. The device of claim 8, wherein a velocity of said applicator after being struck by said least one percussion part (20; 20′, 21′) is less than or equal to 5 m/s.

11. The device of claim 8, wherein said applicator has a blunt distal end.

12. The device of claim 1, wherein said impact body is composed of a material selected from the group consisting of metals, metal alloys, plastic.

13. The device of claim 1, wherein said at least one percussion part is composed of a material selected from the group consisting of metals, metal alloys, plastic.

14. The device of claim 1, wherein said at least one percussion part is harder than said impact body.

15. The device of claim 1, wherein a maximum stroke of the back and forth movement of said at least one percussion part is greater than or equal to 5 cm.

16. The device of claim 1, wherein a pressure provided by said pneumatic drive is less than or equal to 6 bar.

17. The device of claim 1, wherein a plurality of percussion parts are provided that strike against said impact body.

18. The device of claim 17, wherein said percussion parts can have pressure applied thereto independently of one another.

19. The device of claim 17, wherein said percussion parts strike against said impact body one after the other.

20. The device of claim 17, wherein said percussion parts strike against said impact body together.

21. The device of claim 17, wherein said percussion parts run in guide tubes which are arranged concentrically with respect to one another and to each of which pressure can be applied.

22. The device of claim 1, wherein said pneumatic drive has at least one valve which can be controlled by said control system and via which pressure is applied to said at least one percussion part.

23. The device of claim 21, wherein said pneumatic drive has at least two valves which can be controlled by said control system and which can be controlled alternately.

24. The device of claim 1, wherein a retainment chamber is assigned to a side of said at least one percussion part directed away from the pressure application side.
